(19) United States
(12) Patent Application Publication
(10) Pub. No.: US 2010/0161439 A1
(43) Pub. Date: Jun. 24, 2010

(54) ASSET DISCOVERY AND TRANSFER WITHIN A VIRTUAL UNIVERSE

(75) Inventors: Rick A. Hamilton, II, Charlottesville, VA (US); Robert C. McGinley, Olympia, WA (US); Brian M. O'Connell, Cary, NC (US); Clifford A. Pickover, Yorktown Heights, NY (US); Keith R. Walker, Austin, TX (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/339,380

(22) Filed: Dec. 19, 2008

(51) Int. Cl. G06Q 30/00; G06Q 99/00

(52) U.S. Cl. 705/26; 705/1.1

(57) ABSTRACT

An invention for discovery and transfer of assets in a virtual universe is provided. In one embodiment, there is an asset transfer utility, including an inventory component configured to display to a user within a virtual universe an inventory containing a plurality of assets owned by other users within the virtual universe, each of the plurality of assets listed anonymously. A search component is configured to search the inventory containing the plurality of assets. A selection component is configured to select a set of assets from the plurality of assets based on the search. A transfer component is configured to transfer the set of assets between the user and an owner of each of the set of assets.

### FIELD OF THE INVENTION

This invention relates generally to virtual universes and more specifically to the transfer of virtual content in a virtual universe.

### BACKGROUND OF THE INVENTION

Virtual universes (VUs) or virtual worlds are computer-based simulated environments intended for its users or residents to inhabit and interact via avatars, which are personas or representations of the users of the virtual universes. These types of virtual universes are now most common in multiplayer online games, such as Second Life®, which is a trademark of Linden Research Inc. in the United States. Avatars in these types of virtual universes, which can number well over a million, have a wide range of business and social experiences.

Some VUs allow users to create their own assets using software to design three-dimensional (3-D) models and environment programming interfaces. Many of these assets have value to other members of the environment, but are difficult to find without using word of mouth, or knowing the asset owner. The users who posses and develop the assets typically have limited knowledge of the available market, as well as few ways to contact potential customers. Once an asset of value is found, the interested party must then interact with the owner to offer a trade or sale of the asset. This process is time-consuming, and lacks privacy for all parties involved. Lack of anonymity causes many transactions to go unfulfilled.

Prior-art systems also lack an escrow ability that allows a prospective buyer to evaluate an asset to ensure it meets the buyer's needs. Further, there is no automated recourse to reclaim the asset in the event the asset is provided to the prospective buyer for an evaluation period, and the prospective buyer decides to simply keep the asset.

### SUMMARY OF THE INVENTION

In one embodiment, there is a method for discovering and transferring assets within a virtual universe. In this embodiment, the method comprises: displaying to a user within a virtual universe an inventory containing a plurality of assets that are owned by other users, each of the plurality of assets listed anonymously; searching the inventory containing the plurality of assets; selecting a set of assets from the plurality of assets based on the searching; and transferring the set of assets between the user and an owner of each of the set of assets.

In a second embodiment, there is a computer system for discovering and transferring assets within a virtual universe. In this embodiment, the system comprises at least one processing unit and memory operably associated with the at least one processing unit. An asset transfer utility is storable in memory and executable by the at least one processing unit. The asset transfer utility comprises: an inventory component configured to display to a user within a virtual universe an inventory containing a plurality of assets, each of the plurality of assets owned by other users within the virtual universe and listed anonymously; a search component configured to search the inventory containing the plurality of assets; a selection component configured to select a set of assets from the plurality of assets based on the searching; and a transfer component configured to transfer the set of assets between the user and an owner of each of the set of assets.

In a third embodiment, there is a computer-readable medium storing computer instructions, which when executed, enables a computer system to provide discovery and transfer of assets within a virtual universe. In this embodiment, the computer instructions comprise: displaying to a user within a virtual universe an inventory containing a plurality of assets, each of the plurality of assets owned by other users within the virtual universe and listed anonymously; searching the inventory containing the plurality of assets; selecting a set of assets from the plurality of assets based on the searching; and transferring the set of assets between the user and an owner of each of the set of assets.

In a fourth embodiment, there is a method for deploying an asset transfer utility for use in a computer system that provides discovery and transfer of assets within a virtual universe. In this embodiment, a computer infrastructure is provided and is operable to: display to a user within a virtual universe an inventory containing a plurality of assets, each of the plurality of assets owned by other users within the virtual universe and listed anonymously; search the inventory containing the plurality of assets; select a set of assets from the plurality of assets based on the searching; and transfer the set of assets between the user and an owner of each of the set of assets.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some of the functionalities provided by the server array shown in FIG. 1;

FIG. 5 shows an asset transfer utility according to one embodiment of this invention that operates in the environment shown in FIG. 1;

FIG. 6 shows a schematic of an exemplary computing environment in which elements of the networking environment shown in FIG. 1 may operate; and

FIG. 7 shows a flow diagram of a method for discovering and transferring assets in the virtual universe according to one embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to asset discovery and transfer within a virtual universe, such that assets are transferred between a user and an asset owner. In these embodiments, an asset transfer utility provides the capability to discover and transfer assets within the virtual universe. The asset transfer utility comprises an inventory component configured to display to a user within a virtual universe an inventory containing a plurality of assets that owned by other users, each of the plurality of assets listed anonymously. A search component is configured to search the inventory containing the plurality of assets, and a selection component is configured to select a set of assets (i.e., one or more) from the plurality of assets based on the search. A transfer component is configured to transfer the set of assets between the user and an owner of each of the set of assets.

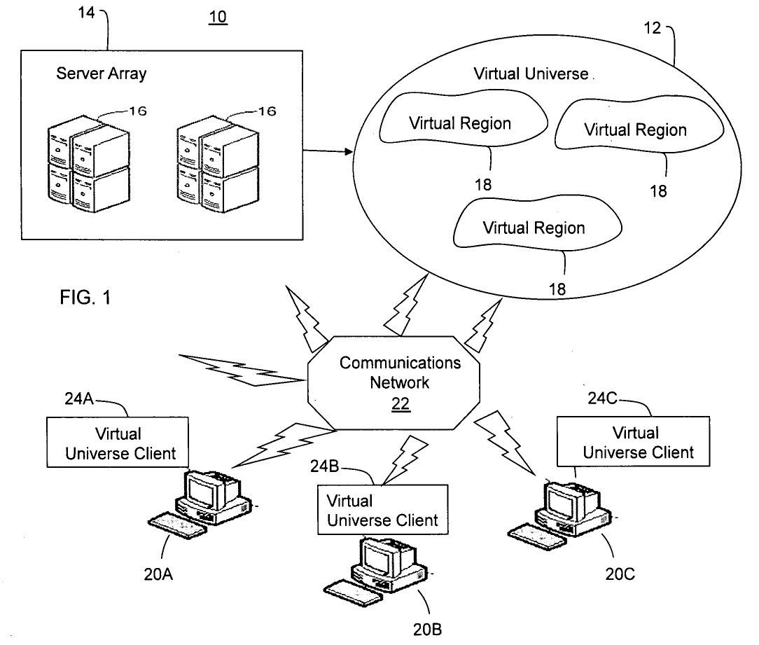

FIG. 1 shows a high-level schematic diagram showing a networking environment 10 for providing a virtual universe 12 according to one embodiment of this invention in which a service for discovering and transferring assets within the virtual universe can be utilized. As shown in FIG. 1, networking environment 10 comprises a server array or grid 14 comprising a plurality of servers 16 each responsible for managing a portion of virtual real estate within virtual universe 12. A virtual universe provided by a multiplayer online game, for example, can employ thousands of servers to manage all of the virtual real estate. The virtual content of the virtual real estate that is managed by each of servers 16 within server array 14 shows up in virtual universe 12 as a virtual region 18 made up of objects, textures and scripts. Like the real-world, each virtual region 18 within virtual universe 12 comprises a landscape having virtual content, such as buildings, stores, clubs, sporting arenas, parks, beaches, cities and towns all created by administrators or residents of the universe that are represented by avatars. These examples of virtual content are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20C (hereinafter referred generally as 20) interact with virtual universe 12 through a communication network 22 via virtual universe clients 24A-24C (hereinafter referred generally as 24) that reside in computers 20, respectively. Below are further details of virtual universe 12, server array 14, and virtual universe client 24.

One of the ways that users of virtual universe 12 can use virtual universe client 24 to interact with the universe is to create virtual content or assets for the virtual universe. An illustrative but non-limiting listing of assets that can be created through virtual universe client 24 includes items such as apparel for avatars, animations for a multitude of purposes (instructional material), avatar accessories (e.g., jewelry, hairpieces, clothing, etc.), scripts for performing certain functions in the virtual universes, building components, avatar appearance features, recreational equipment (e.g., bicycles), automobiles, etc. As will be further described herein, embodiments of this invention are directed to facilitating the discovery and transfer of these assets between users of virtual universe 12.

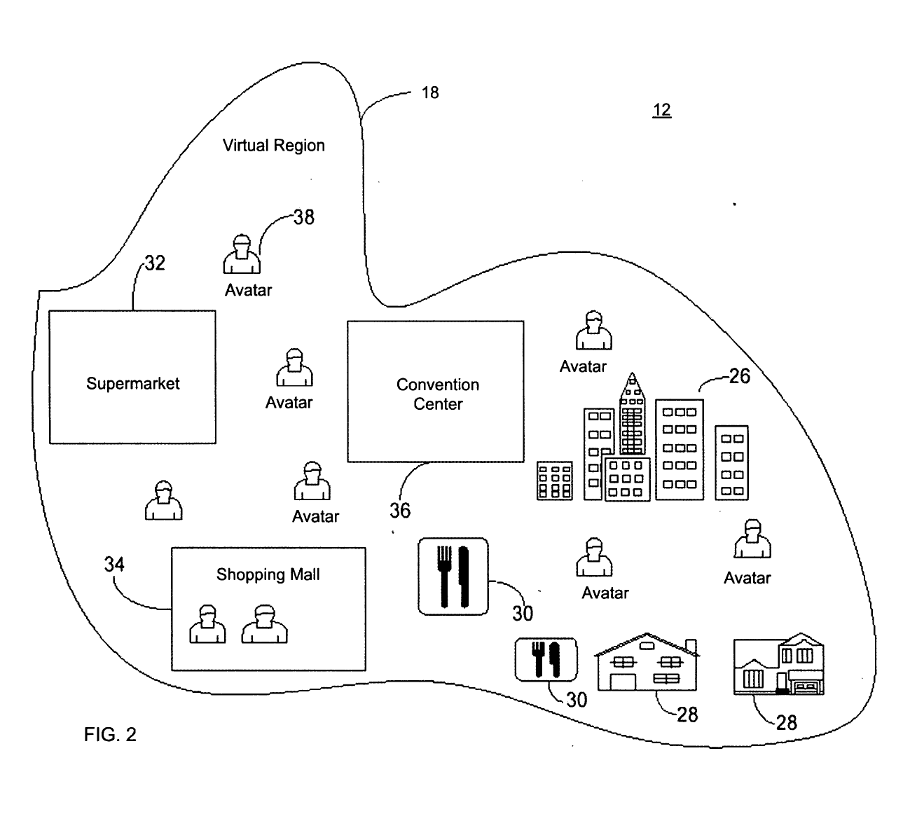

FIG. 2 shows a more detailed view of what one virtual region 18 in virtual universe 12 may comprise. As an example, virtual region 18 shown in FIG. 2 comprises a downtown office center 26, homes 28, restaurants 30, a supermarket 32 and a shopping mall 34 for shopping, and a convention center 36 for meetings and various conventions. Residents or avatars 38, which as mentioned above, are personas or representations of the users of the virtual universe, roam all about the virtual region by walking, driving, flying or even by teleportation or transportation, which is essentially moving through space from one point to another, more or less instantaneously. These examples of virtual content in virtual region 18 shown in FIG. 2 are only illustrative of some items that may be found in a virtual region and those skilled in the art will recognize that these regions can have many more items that can be found in the real world universe as well as things that do not presently exist in the real world.

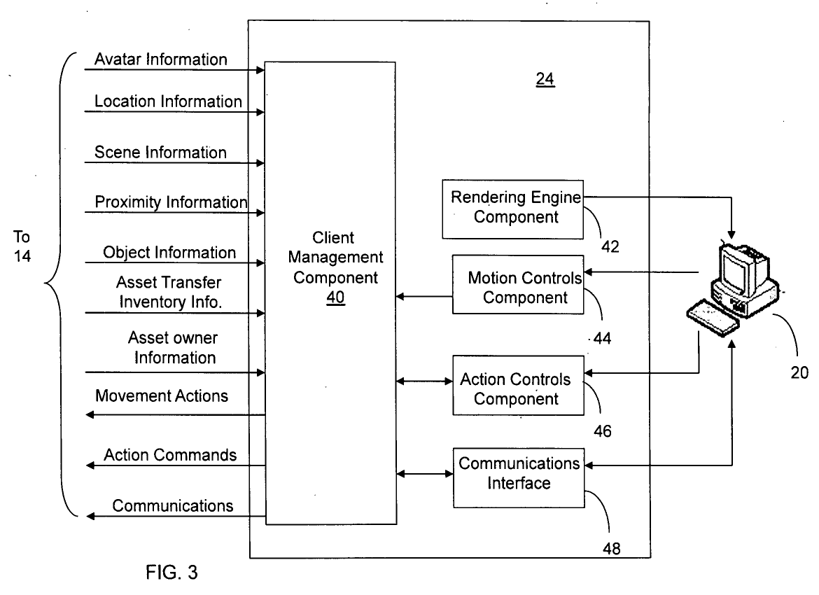

FIG. 3 shows a more detailed view of virtual universe client 24 shown in FIG. 1. Virtual universe client 24, which enables users to interact with virtual universe 12, comprises a client management component 40, which manages actions, commands and communications made by a user through computer 20, and information received from the virtual universe through server array 14. A rendering engine component 42 enables the user of computer 20 to visualize his or her avatar within the surroundings of the particular region of virtual universe 12 that the avatar is presently located.

A motion controls component 44 enables the user's avatar(s) to make movements through the virtual universe. In one embodiment, movements through the virtual universe can include, for example, gestures, postures, walking, running, driving, flying, etc. An action controls component 46 enables the user to perform actions in the virtual universe such as buying items for his or her avatar or even for their real-life selves, building homes, planting gardens, etc. These actions are only illustrative of some possible actions that a user can perform in the virtual universe and are not limiting. A communications interface 48 enables a user to communicate with other users of virtual universe 12 through modalities such as chatting, instant messaging, gesturing, talking and electronic mail (e-mail).

FIG. 3 shows the various types of information received by client management component 40 from the virtual universe through the server array 14. In particular, client management component 40 receives avatar information about the avatars that are in proximity to the user's avatar. In addition, client management component 40 receives location information about the area that the user's avatar is near (e.g., what region or island he or she is in), as well as scene information (e.g., what the avatar sees). Client management component 40 also receives proximity information, which contains information on what the user's avatar is near, and object information, which is information about nearby objects. Client management component 40 receives asset transfer inventory information, which includes information about the assets within asset transfer utility 53, and asset owner information, which includes information about the assets held by each individual user of virtual universe 12. FIG. 3 also shows the movement commands and action commands that are generated by the user and sent to the server array via client management component 40, as well as the communications that can be sent to the users of other avatars within the virtual universe.

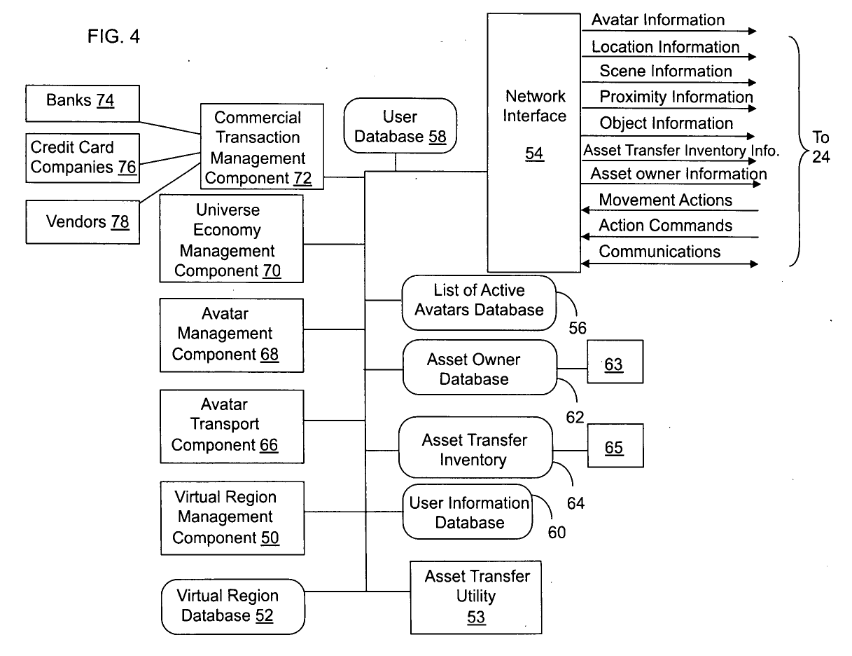

FIG. 4 shows a more detailed view of some of the functionalities provided by server array 14 shown in FIG. 1. In particular, FIG. 4 shows a virtual region management component 50 that manages a virtual region(s) within the virtual universe. Virtual region management component 50 manages what happens in a particular region, such as the type of landscape in that region, the number of homes, commercial zones, boutiques, streets, parks, restaurants, etc. For example, virtual region management component 50 would allow the owner of a particular region or establishment within the region to specify requirements for entering or remaining within the region that could potentially affect certain avatar characteristics. Those skilled in the art will recognize that virtual region management component 50 can manage many other facets within the virtual region.

FIG. 4 shows a network interface 54 that enables server array 14 to interact with virtual universe client 24 residing on computer 20. In particular, network interface 54 communicates avatar, location, scene, proximity, script, object, asset transfer inventory, and asset owner information to the user through virtual universe client 24. The network interface receives movement and action commands, as well as communications from the user via virtual universe client 24.

FIG. 4 also shows an asset transfer utility 53, which provides the capability to discover and transfer assets in the virtual universe, as will be further described below. In this embodiment, asset transfer utility 53 resides on the same computer system as server array 14, and communicates directly to virtual universe 12 and its users via virtual universe client 24. In other embodiments, asset transfer utility 53 might reside on the same computer as virtual universe client 24, have components that reside on both server array 14 and virtual universe client 24, or reside on separate computers in direct communication with virtual universe servers 16 and virtual universe clients 24.

As shown in FIG. 4, there are several different databases for storing information. In particular, virtual region database 52 stores information on all of the specifics in virtual region 18 that virtual region management component 50 is managing. Virtual region database 52 contains metadata information about the objects, texts and scripts associated with the virtual content in the virtual region(s). List of active avatars database 56 contains a list of all the avatars that are online in the virtual universe 12, while databases 58 and 60 contain information on the actual human users of virtual universe 12. In one embodiment, user database 58 contains general information on the users such as names, email addresses, locales, interests, ages, preferences, etc., while user information database 60 contains more sensitive information on the users such as billing information (e.g., credit card information) for taking part in transactions.

Databases 62 and 64 contain information on the avatars of the users that reside in virtual universe 12. In one embodiment, asset owner database 62 contains information on the assets owned within the personal inventories of each asset owner of the virtual universe. The information is typically in the form of metadata associated with the virtual content available for use by each user's avatar(s). An illustrative but non-limiting listing of assets that can be present in asset owner database 62 includes clothing, virtual pets, vehicles, electronic media (e.g., music files), or other possessions. Those skilled in the art will recognize that this listing of assets is illustrative of possible assets and is not exhaustive. For example, other assets may include graphics files, sound files, animations, electronic documents, video files, avatar accessories, avatar body parts, avatar tools or other objects, calling cards, note cards, photos and photo albums, or any other type of asset.

Each inventory asset may be associated with a piece of executable code or other data, called a script, which may affect rendering in some fashion during a session in the virtual universe. A clothing asset, for example, may be rendered with a script that causes the clothing to shimmer. A virtual pet, in another example, may render as an automated avatar that follows the user's avatar within the virtual universe.

Asset transfer inventory 64 is a database that contains an inventory listing of assets within asset transfer utility 53. Asset transfer inventory 64 also contains information about the assets belonging to each of the users having assets within asset transfer utility 53. Asset transfer inventory 64 operates with asset owner database 62 to transfer assets for display and discovery using asset transfer utility 53. In an exemplary embodiment, asset transfer inventory 64 comprises a listing table 65 having a foreign key to an asset table 63 within asset owner database 62, such that querying the asset transfer inventory 64 pulls information from asset table 63 to listing table 65. In an exemplary embodiment, asset transfer inventory 64 is dynamically updated with new information as the content within asset owner database 62 changes. Assets can be transferred between asset owner database 62 and asset transfer inventory 64 as a batch process executed manually by an administrator, or automatically on a schedule, such as during a non-peak usage time. Alternatively, assets can be transferred as a batch process each time a user initiates a search using asset transfer utility 53. Those skilled in the art will recognize that other techniques for transferring data between databases 62 and 64 are possible within the scope of the invention.

Those skilled in the art will also recognize that databases 58-64 may contain additional information if desired. Databases 58-64 may be consolidated into a single database or table, divided into multiple databases or tables, or clustered into a database system spanning multiple physical and logical devices. Further, although the above information is shown in FIG. 4 as being stored in databases, those skilled in the art will recognize that other configurations and means of storing information can be utilized. For example, asset transfer inventory 64 and asset owner database 62 might reside on the same computers as virtual universe client 24, have components that reside on both server array 14 and virtual universe client 24, or reside on separate computers in direct communication with virtual universe servers 16 and virtual universe client 24.

An avatar transport component 66 enables users to transport, which as mentioned above, allows avatars to transport through space from one point to another point, instantaneously. As a result, an avatar could for example travel from a business region to an entertainment region to experience a concert.

An avatar management component 68 keeps track of what the avatars are doing while in the virtual universe. For example, avatar management component 68 can track where each avatar is presently located in the virtual universe, as well as what activities it is performing or has recently performed. An illustrative but non-exhaustive list of activities can include shopping, eating, talking, recreating, etc.

Because a typical virtual universe has a vibrant economy, server array 14 has functionalities that are configured to manage the economy. In particular, a universe economy management component 70 manages transactions that occur within the virtual universe between avatars. In one embodiment, virtual universe 12 will have its own VU currency ($VU) that users pay for with real-life money. The users can then take part in commercial transactions for their avatars through universe economy management component 70. For example, an avatar might want to pay for a service that provides discovery and transfer of assets within the virtual universe. In this case, the avatar would make the purchase of this service using the $VU. In some instances, the user may want to take part in a commercial transaction that benefits him or her and not an avatar. In this case, a commercial transaction management component 72 allows the user to participate in the transaction. For example, while walking around a commercial zone, a user may see a pair of shoes that he or she would like for themselves and not the user's avatar. In order to fulfill this type of transaction and others similarly related, commercial transaction management component 72 interacts with banks 74, credit card companies 76 and vendors 78.

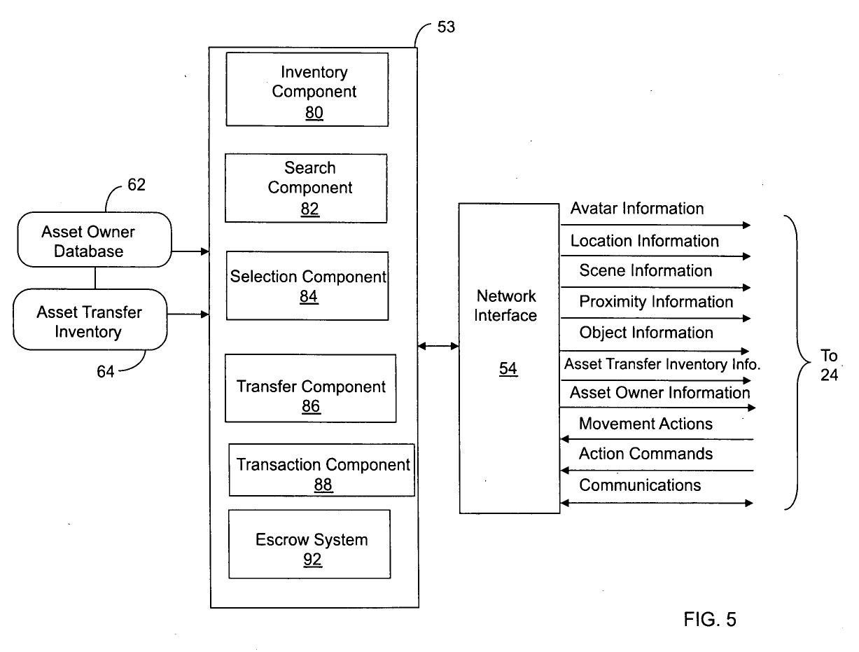

Referring now to FIG. 5, asset transfer utility 53 according to embodiments of the invention will be described in further detail. As shown in FIG. 5, asset transfer utility 53 comprises an inventory component 80 configured to display to a user within virtual universe 12 an inventory containing a plurality of assets (e.g., asset transfer inventory 64) that are owned by other users in the virtual universe. Inventory component 80 is configured to list each of the plurality of assets anonymously, such that the identity of the owner of each of the plurality of assets is unknown by the user, and the identity of the user is unknown by the owner of each of the plurality of assets. The user can buy, bid, lease, or trade an asset even though the identity of the asset owner is unknown. This allows anonymity in both directions, protecting the identity of users and the asset owners. In one embodiment, if either the user or the asset owner chooses to be anonymous in the transaction, all parties in the transaction will be kept anonymous.

Asset owners may declare assets within their personal inventories public, but also anonymous, thus allowing an anonymously listed asset to be discovered by the user via inventory component 80. Restrictions may be placed on the assets to limit the users who may view the assets. The asset owner may set an asset to be visible by everyone, a particular group, or an individual. Further, public assets can be placed into asset categories that describe the asset. For example, an asset owner may create a working 3-D replica of a Model-T automobile and load the vehicle into the VU. The asset owner then sets the asset category to “Vehicle-Automobile-Replica-Pre-20's,” for example, and edits the asset description to include the words Ford-Model T-historic-antique-sound-horn-wipers-white walls. An asset search for “Ford Model T” would now return this asset.

In another embodiment, inventory component 80 is configured to automatically replace an asset within asset transfer inventory 64 with an asset from asset owner inventory 62. For example, an asset owner may wish to replace a transferred asset with another asset from the asset owner's personal inventory. This allows the asset owner to control the market for his/her assets, and determine how much inventory to make publicly available. It also allows the asset owner to present a consistent display of merchandise without daily monitoring. Consider, for example, an asset owner who develops a new clothing garment that is quickly becoming popular in the VU. In order to maintain demand, the asset owner may choose to sell only one garment every seven days. If the first garment gets sold on the first day it is for sale, inventory component 80 will take another garment from the asset owner's private inventory, and declare the asset publicly available only after six more days have passed. In this embodiment, inventory component 80 automatically keeps the asset owner's public asset inventory constant, so that there is always the same number of assets for sale, bid, lease, etc. In the event a replacement asset is not available, no asset is declared public, and the asset is not replaced.

As shown in FIG. 5, asset transfer utility 53 further comprises a search component 82 configured to search the plurality of assets within the inventory. Users can search for assets using keyword searches, or by drilling down through category hierarchies. In an exemplary embodiment, search component 82 comprises a search interface (not shown) that allows users to enter keywords to search for assets. The keywords are matched against the asset description and asset name, as well as the category names that may have been established. A selection component 84 is configured to select and return to the user a set of assets from the plurality of assets based on the search. In one embodiment, the set of assets may be an asset list organized according to relevancy. Users may alter the asset list using several categories including, but not limited to asset type, value, or asset owner. For example, a user may find a building style and texture within the asset list that he or she desires, but the building is smaller than the one sought. The user may re-order the asset list by asset owner to see if there are any larger buildings being offered by the same asset owner.

Selection component 80 is configured to display feedback for each of the set of assets, such as a numerical rating or written review of each asset. If an asset owner allows feedback for his or her public asset(s), a user who buys or leases the asset, for example, may be given permission to leave a comment about the asset. Users may also be granted permission to provide a numerical rating that indicates a level of satisfaction with the asset. Therefore, subsequent users who discover these assets may review the feedback as a way to research product satisfaction and asset usability.

Following asset discovery, the selected set of assets can be transferred to the user using a transfer component 86 shown in FIG. 5. Specifically, transfer component 86 is configured to transfer the set of assets between the user and the owner of each of the set of assets. As will be described in further detail below, transfer component 86 transfers the set of assets to the user by performing at least one of the following: selling the set of assets, leasing the set of assets, or trading the set of assets.

In one embodiment, the asset owner may wish to sell his or her asset(s). Assets configured for “sale” are assigned a price and are generally made available for purchase immediately without restriction. When a user discovers an asset that is for sale, the user may select the asset, view its description and price, and purchase the asset. If the user chooses to buy the asset, and the asset price is confirmed with the buyer, the funds or other form of payment are sent from the user's account to the seller's (i.e., the asset owner's), and the asset is moved from the seller's inventory, to the user's. In some instances asset transfer utility 53 may charge a brokerage fee for completing this transaction.

Assets configured for “bid” by the asset owner are assigned an initial recommended bid offer. The recommended bid offer is the value desired by the asset owner, and may therefore represent a suggested bid offer and/or a minimum acceptable bid offer. When a user discovers an asset that is available for bid, the bidder (i.e., the user) can enter the bid amount, as well as the quantity of the item sought. The bidder then submits the bid to the asset owner. At the time of submission, transfer component 86 deducts the bid amount from the bidder's account and enters those funds into an escrow system 92 shown in FIG. 5. Escrow system 92 then sends a bid message to the asset owner using a VU messaging or e-mail system. When the asset owner receives the bid, the asset owner can accept, reject, or counter the bid offer. If the asset owner accepts the bid, the funds are withdrawn from escrow system 92 and deposited into the asset owner's account, and the asset is transferred to the bidder's personal inventory. If the bid is rejected, the funds are returned to the bidder's account, and the bidder is sent a rejection message.

If the asset owner counters the offer, the asset owner enters a new amount and sends the bid back to the bidder. The bidder's initial funds are returned to his or her account from escrow system 92. Once the counter offer is received, the bidder may accept the counter offer and pay for the asset immediately, reject the counter offer, or counter with another offer, which will deposit the latest offer amount in the escrow system 92. If the bid is not accepted, rejected, or countered within a specific period of time, the bid is withdrawn and the bidder receives the bid amount back.

In another embodiment, assets can be configured with bid response automation. Bid response automation allows an asset owner to set up the desired behavior for assets they have placed up for bid. Assets that are placed up for bid can be set to auto-respond to bidders within a specified range of the recommended bid offer. For example, an asset owner places an asset up for bid and sets the recommended bid offer to 5 $VU with an automated bid response to accept all offers at or below 20% of the recommended bid value. If a bidder places an offer on the asset of 4 $VU, the automated bid response would accept the offer of 4 $VU and the transaction would be completed. If the offer is below the recommended bid offer, the offer is automatically rejected. This automated bid response allows asset owners to place items up for sale and not have the burden of accepting and rejecting bids before the bid expires.

Assets that are set for “trade” within the virtual universe are similar to assets for bid except that assets for trade may have a recommended trade item. The recommended trade item is an item(s) the asset owner is seeking in exchange for his or her asset. Once the user submits the trade offer, the assets are placed in escrow system 92, and the asset owner is sent a message detailing the trade offer. When the asset owner receives the trade offer, they may accept or reject the offer. Accepted offers will immediately withdraw assets and any funds from escrow system 92 into the asset owner's account, and move the asset into the user's personal inventory. Offers that are not accepted or rejected within a specific period of time are rejected, and assets and funds are returned to the user's account.

In another embodiment, assets may be offered for lease. Asset owners may rent or lease assets for a predetermined time interval, as well as for a fixed price. Leased assets are discovered in the same way as assets for sale, bid, or trade, but differ in that they are never actually owned by the lessee (i.e., the user). Instead, leased assets expire at the end of the predetermined time interval, and are returned to the asset owner's inventory where they can be leased again. For example, a VU region owner may host a party event to celebrate the release of a new product line. Accordingly, the virtual region owner may construct a virtual venue asset to host the event. Using transfer component 86 of the present invention, the region owner could lease the venue asset complete with dance floors, seating for guests, presentation recording and playback, etc. Once the event is done, the venue asset is returned to the virtual region owner.

Furthermore, certain assets discovered by the user may benefit from a demonstration, evaluation or check-out period prior to transfer. In one embodiment, selection component 84 is configured to provide the user with temporary access to the set of assets during the evaluation period. If the user decides to accept one or more of the set of assets, selection component 84 transfers the set of assets to the user during the evaluation period. However, if the evaluation period expires without acceptance from the user, or if the asset owner requests that an asset be returned, selection component 84 is configured to return the set of assets to the owner of each of the set of assets. For example, a user may wish his or her avatar to try on a bathing suit in a virtual dressing room prior to purchasing it. The user takes temporary possession of the bathing suit and has access to it for an evaluation period with the option to purchase the bathing suit at anytime during the evaluation. If the user chooses not to purchase the clothing asset, or the evaluation period has expired, the clothing asset is returned to the asset owner. In some embodiments, the evaluation period may be implemented as a teleport offer, where the potential buyer may teleport to the location of the asset or asset owner. In cases where a teleport is not possible, the asset may be temporarily placed in the potential buyer's inventory or otherwise teleported to the potential buyer. The server may prevent modifications to the asset while under evaluation, or may cache the original object properties and restore the properties from the cache upon return to the owner.

As described herein, the present invention allows for the discovery and transfer of assets in a VU. The present invention provides an asset transfer utility for displaying, trading, buying, selling, or leasing assets in the VU. Asset buyers and sellers may choose to buy and sell assets anonymously, allowing the asset transfer utility of the present invention to serve as a broker in a double-blind transaction. The present invention allows for assets to be evaluated, demonstrated, or used temporarily through an escrow style service that protects both parties in the transaction.

In another embodiment of this invention, asset transfer utility 53 is used as a service to charge fees for each asset transfer invoked. As shown in FIG. 5, asset transfer utility 53 comprises a transaction component 88 configured to charge a transaction fee for facilitating the discovery and/or transfer of assets between the user and the owner(s) of the asset(s). In this embodiment, the provider of the virtual universe or a third party service provider could offer this transaction as a service by performing the functionalities described herein on a subscription and/or fee basis. In this case, the provider of the virtual universe or the third party service provider can create, deploy, maintain, support, etc., asset transfer utility 53 that performs the processes described in the invention. In return, the virtual universe or the third party service provider can receive payment from the virtual universe residents via universe economy management component 70 and commercial transaction management component 72 (FIG. 4).

In still another embodiment, the methodologies disclosed herein can be used within a computer system to provide discovering and transferring of assets in a virtual universe. In this case, asset transfer utility 53 can be provided, and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

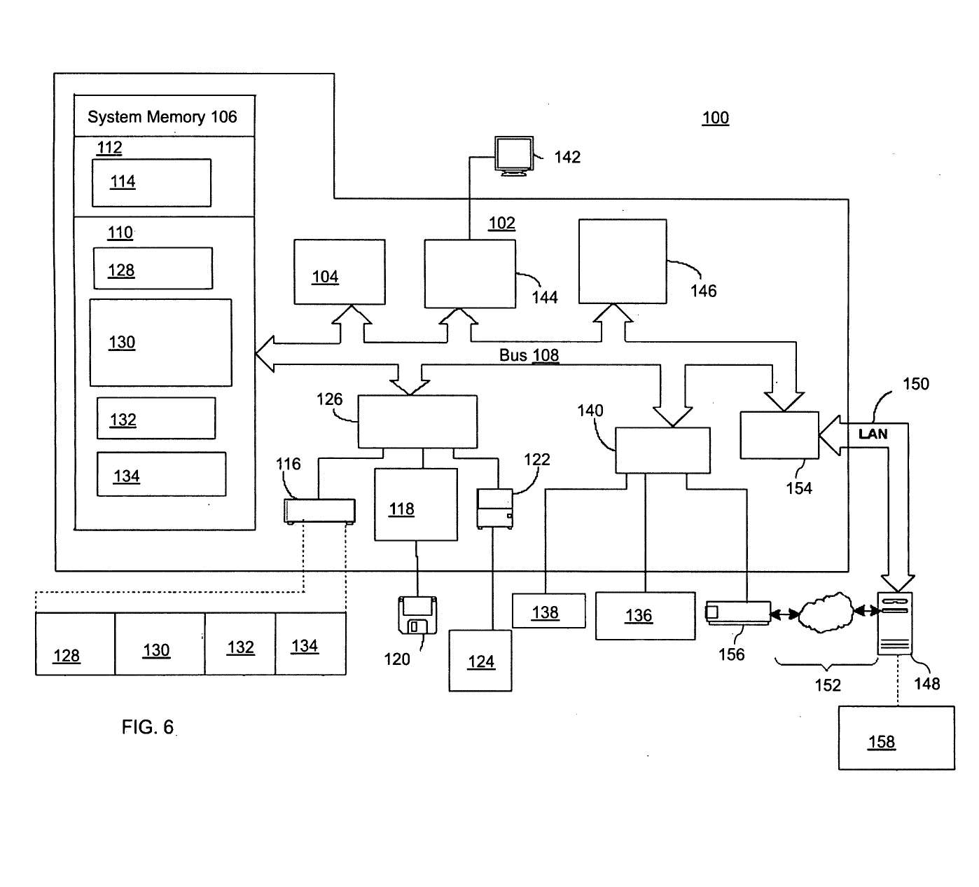

FIG. 6 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should computing environment 100 be interpreted as having any dependency or requirement relating to any one or combination of components illustrated in FIG. 6.

In the computing environment 100 there is a computer 102, which is operational with numerous other general purpose or special purpose computing system environments or configurations. Examples of well known computing systems, environments, and/or configurations that may be suitable for use with computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Computer 102 may be described in the general context of computer-executable instructions, such as program modules, being executed by a computer. Generally, program modules include routines, programs, objects, components, logic, data structures, and so on that perform particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 6, computer 102 in the computing environment 100 is shown in the form of a general-purpose computing device. The components of computer 102 may include, but are not limited to, one or more processors or processing units 104, a system memory 106, and a bus 108 that couples various system components including system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer 102 typically includes a variety of computer readable media. Such media may be any available media that is accessible by computer 102, and it includes both volatile and non-volatile media, removable and non-removable media.

In FIG. 6, system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 6 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. Hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including server array 14 and virtual universe client 24. In one embodiment, the one or more application programs 130 include components of asset transfer utility 53, such as inventory component 80, search component 82, selection component 84, transfer component 86, transaction component 88, and escrow system 92.

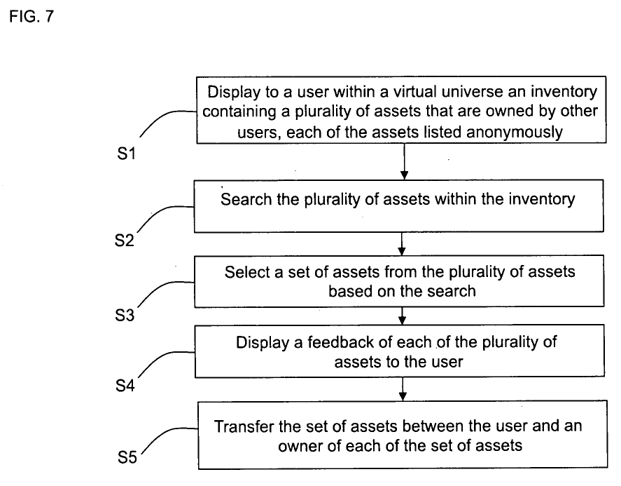

The one or more program modules 130 carry out the methodologies disclosed herein, as shown in FIG. 7. According to one embodiment, in step S1, a user within a virtual universe is displayed an inventory containing a plurality of assets that are owned by other users, each of the plurality of assets listed anonymously. In S2, the plurality of assets within the inventory is searched. In S3 a set of assets is selected from the plurality of assets based on the search. In S4, a feedback of each of the plurality of assets is displayed to the user. In S5, the set of assets is transferred.

The flowchart of FIG. 7 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Referring back to FIG. 6, a user may enter commands and information into computer 102 through optional input devices such as a keyboard 136 and a pointing device 138 (e.g., a “mouse”). Other input devices (not shown) may include a microphone, joystick, game pad, satellite dish, serial port, scanner, camera, or the like. These and other input devices are connected to processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 6 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to system bus 108 via the user input interface 140 or other appropriate mechanism.

In a networked environment, program modules depicted relative to the personal computer 102, or portions thereof, may be stored in a remote memory storage device. By way of example, and not limitation, FIG. 6 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for discovering and transferring assets within a virtual universe. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for discovering and transferring assets in a virtual universe, comprising:
displaying to a user within a virtual universe an inventory containing a plurality of assets that are owned by other users, each of the plurality of assets listed anonymously;
searching the inventory containing the plurality of assets;
selecting a set of assets from the plurality of assets based on the searching; and
transferring the set of assets between the user and an owner of each of the set of assets.

2. The method according to claim 1, the transferring comprising performing at least one of the following: selling the set of assets, leasing the set of assets, or trading the set of assets.

3. The method according to claim 1, an identity of an owner of each of the plurality of assets being unknown by the user, and an identity of the user being unknown by the owner of each of the plurality of assets.

4. The method of claim 1 further comprising providing the user with temporary access to the set of assets during an evaluation period.

5. The method of claim 4 further comprising performing one of the following: transferring the set of assets to the user during the evaluation period, returning the set of assets to the owner of each of the set of assets at an expiration of the evaluation period, or returning the set of assets to the owner of each of the set of assets at a request of the owner of each of the set of assets.

6. The method of claim 1 further comprising displaying a feedback for each of the set of assets.

7. The method of claim 1 further comprising assessing a transaction fee for facilitating the transfer of the set of assets between the user and the owner of each of the set of assets.

8. A computer system for discovering and transferring assets in a virtual universe, comprising:
at least one processing unit;
memory operably associated with the at least one processing unit; and
an asset transfer utility storable in memory and executable by the at least one processing unit, the asset transfer utility comprising:
an inventory component configured to display to a user within a virtual universe an inventory containing a plurality of assets, each of the plurality of assets owned by other users within the virtual universe and listed anonymously;
a search component configured to search the inventory containing the plurality of assets;
a selection component configured to select a set of assets from the plurality of assets based on the search; and
a transfer component configured to transfer the set of assets between the user and an owner of each of the set of assets.

9. The asset transfer utility according to claim 8, the transfer component configured to perform at least one of the following: sell the set of assets, lease the set of assets, or trade the set of assets.

10. The asset transfer utility according to claim 8, an identity of an owner of each of the plurality of assets being unknown by the user, and an identity of the user being unknown by the owner of each of the plurality of assets.

11. The asset transfer utility according to claim 8, the selection component further configured to provide the user with temporary access to the set of assets during an evaluation period.

12. The asset transfer utility according to claim 11, the selection component further configured to perform one of the following: transfer the set of assets to the user during the evaluation period, return the set of assets to the owner of each of the set of assets at an expiration of the evaluation period, or return the set of assets to the owner of each of the set of assets at a request of the owner of each of the set of assets.

13. The asset transfer utility of claim 8, the selection component further configured to display a feedback for each of the set of assets.

14. The asset transfer utility of claim 8 further comprising a transaction component configured to charge a transfer fee for facilitating the transfer of the set of assets between the user and the owner of each of the set of assets.

15. A computer-readable medium storing computer instructions, which when executed, enables a computer system to discover and transfer assets in a virtual universe, the computer instructions comprising:
displaying to a user within a virtual universe an inventory containing a plurality of assets, each of the plurality of assets owned by other users within the virtual universe and listed anonymously;
searching the inventory containing the plurality of assets;
selecting a set of assets from the plurality of assets based on the searching; and
transferring the set of assets between the user and an owner of each of the set of assets.

16. The computer-readable medium according to claim 15 further comprising instructions for performing at least one of the following: selling the set of assets, leasing the set of assets, or trading the set of assets.

17. The computer-readable medium according to claim 15, an identity of an owner of each of the plurality of assets being unknown by the user, and an identity of the user being unknown by the owner of each of the plurality of assets.

18. The computer-readable medium according to claim 15 further comprising instructions for providing the user with temporary access to the set of assets during an evaluation period.

19. The method of claim 18 further comprising instructions for performing one of the following: transferring the set of assets to the user during the evaluation period, returning the set of assets to the owner of each of the set of assets at an expiration of the evaluation period, or returning the set of assets to the owner of each of the set of assets at a request of the owner of each of the set of assets.

20. The method of claim 15 further comprising instructions for displaying a feedback for each of the set of assets.

21. The method of claim 15 further comprising instructions for charging a transaction fee for facilitating the transfer of the set of assets between the user and the owner of each of the set of assets.

22. A method for deploying an asset transfer utility for use in a computer system that provides asset discovery and transfer in a virtual universe, comprising:
provide a computer infrastructure operable to:
display to a user within a virtual universe an inventory containing a plurality of assets, each of the plurality of assets owned by other users within the virtual universe and listed anonymously;
search the inventory containing the plurality of assets;
select a set of assets from the plurality of assets based on the searching; and
transferring the set of assets between the user and an owner of each of the set of assets.
